(19) United States
(12) Patent Application Publication
(10) Pub. No.: US 2019/0144068 A1
(43) Pub. Date: May 16, 2019

(54) HANDLEBARS WITH A BASE

(71) Applicant: UJET S.A., Luxembourg (LU)

(72) Inventors: Patrick David, Blaustein (DE); Mariana Grehl, Staig (DE)

(21) Appl. No.: 16/306,957

(22) PCT Filed: Jun. 6, 2017
(86) PCT No.: PCT/EP2017/063655

§ 371 Date: Dec. 4, 2018

(30) Foreign Application Priority Data
Jun. 6, 2016 (DE) 10 2016 110 446.9

(51) Int. Cl. B62K 21/16; B62J 99/00; B62K 23/02

(52) U.S. Cl. CPC B62K 21/16; B62J 99/00; B62K 23/02; B62K 15/006; B62K 2204/00; B62K 2202/00; B62J 2099/0033

(57) ABSTRACT

The invention relates to handlebars (21) having a base (22), in particular for a vehicle, in particular an electrically driven vehicle (10), comprising:
at least one grip support (30, 30′), which is arranged in an articulated manner on the base (22) and is pivotable from a first support position into a second support position;
a holding device (50), which is arranged and/or designed so that the holding device (50) is pivotable in an articulated manner from a first holding position into a second holding position, wherein the holding device (50) locks the grip support (30, 30′) with the base (22) in the first holding position;
a blocking device (40), which is arranged in an articulated manner on the base (22) and is pivotable from a first blocking position into a second blocking position, wherein the blocking device (40) is arranged and/or designed such that the blocking device (40) blocks the holding device (50) in the first blocking position.

The invention relates to handlebars for a vehicle according to Claim 1. Furthermore, the invention relates to a vehicle according to Claim 12.

Motor scooters equipped with electric drives are known, for example, from EP 1 857 314 A2. Corresponding electric motor scooters or motorized two-wheeled vehicles typically have a vehicle body and two wheels, wherein one of the wheels is driven via an electric drive. Furthermore, such motor scooters typically have a handlebar assembly, comprising handlebars having a base and a display unit for displaying items of speed information or the charge state of a battery. In addition, two grips are attached to the handlebars, via which the driver can control the vehicle.

Furthermore, motor scooters are known, which can be collapsed for simple transportation or for storage. In this case, small packing dimensions of the folded motor scooter and a compact shape are important. Protruding components thus make it more difficult to deal with the folded motor scooter.

Proceeding from this prior art, it is the object of the present invention to provide handlebars and/or a vehicle, which contributes to achieving small packing dimensions upon collapsing of the motor scooter.

This object is achieved according to the invention by the subjects of Claims 1 and 12.

Advantageous and expedient embodiments of the handlebars according to the invention are specified in the dependent claims.

In particular, the object is achieved by handlebars having a base. In this case, the handlebars can be handlebars for vehicle, for example, an electric scooter, a motorcycle, or an electrically driven quad bike. The handlebars can also be provided for other non-electrically driven vehicles, for example, a bicycle.

The handlebars having the base comprise at least one grip support (having a handle), which is arranged in an articulated manner on the base and is pivotable from a first support position into a second support position. Furthermore, the handlebars comprise a holding device, which is arranged and/or designed so that it is pivotable in an articulated manner from a first holding position into a second holding position. In this case, the holding device locks the grip support with the base in the first holding position. The handlebars furthermore comprise a blocking device, which is arranged in an articulated manner on the base and is pivotable from a first blocking position into a second blocking position, wherein the blocking device is arranged and/or designed such that the blocking device blocks the holding device in the first blocking position.

The handlebars can thus be collapsed in the scope of the folding procedure of a vehicle, which results in compact packing dimensions. The handlebars comprise a base, which is preferably fixedly connected to a steering column of the handlebars, and at least one grip support, one holding device, and one blocking device. The grip support can have brake levers or a gas lever, for example, in one embodiment. To prevent unintentional collapsing of the handlebars, the blocking device blocks the holding device, so that the at least one grip support cannot be pivoted when the individual components are located in the corresponding positions. It is provided in this case that during the operation of the vehicle, the at least one grip support is located in the first support position, the holding device is located in the first holding position, and the blocking device is located in the first blocking position. The grip support is therefore prevented from being pivoted during operation, since it is held by the holding device, which is in turn secured by the blocking device. Enhanced safety is thus offered during travel.

However, if the vehicle is not in operation and is to be collapsed, the holding device can be unlocked by pivoting the blocking device, so that the holding device may be pivoted into the second holding position. The at least one grip support can thereupon be pivoted into the second support position. This thus enables very simple collapsing of the handlebars by means of a few manipulations and can thus also be carried out by one person.

In one embodiment, the at least one grip support can be held at least partially in a formfitting and/or friction-locked manner in the holding device in the first holding position.

If the at least one grip support is held at least partially in a formfitting manner in the holding device in the first holding position, it is thus ensured that it does not deform even under load, so that a high level of stability is ensured.

Furthermore, in one embodiment the holding device can be mounted on the base via a holding joint so it is rotatable about a holding device axis of rotation.

If the holding device is also arranged via a holding joint on the base, the holding joint is thus an integral component of the base. Enhanced stability of the overall construction is thus ensured. In particular, the stability is enhanced if the holding device locks the at least one grip support, since when the driver exerts pressure on the at least one grip support, high torques act on the holding joint and corresponding forces are transmitted to the base.

In one embodiment, the holding device can be pre-tensioned in the first holding position via a spring element.

In order that the at least one grip support cannot be unintentionally disengaged, the holding device can be pre-tensioned via a spring element in the first holding position. This results in enhanced safety. In addition, it is more comfortable for the driver to operate the holding device if it snaps into the horizontal as a result of the spring upon pivoting of the grip support.

In one embodiment, a recess of the holding device can be formed corresponding to a pin of the at least one grip support.

To implement the locking between the at least one grip support and the holding device, an interaction of a pin of the at least one grip support with a recess of the holding device can be provided. If the recess is formed corresponding to the pin, a particularly good seat of the pin in the recess is then ensured. This also results in enhanced stability. In the described embodiment, however, the safety is enhanced, since unintentional disengagement of the locking is prevented.

In one embodiment, the pin and the recess can be arranged and/or formed such that the pin engages in the recess for locking in the first holding position.

In one embodiment, the pin of the at least one grip support can be arranged inclined at an angle to the longitudinal axis of the at least one grip support.

If the pin is arranged at an angle inclined to the longitudinal axis of the at least one grip support, further improved locking is achieved, since the locking is stable and may be disengaged very easily.

In one embodiment, at least one contact surface of the recess can be formed at least partially following a first radius around the holding device axis of rotation. In one embodiment, the at least one delimitation surface of the pin can be formed at least partially following a second radius around the holding device axis of rotation in the first support position. In one embodiment, the recess and the pin can be formed substantially complementary in this case.

If the contact surface of the recess has an essentially round shape and the delimitation surface of the pin is formed substantially corresponding to the contact surface, the support surface is then large. This means that a material-preserving force introduction is provided.

Furthermore, the holder can be formed in a tapering shape in an insertion direction, for example, substantially transversely to the holding device axis of rotation.

In one embodiment, in which the recess can be formed having a tapering shape in an insertion direction, an intermediate space forms between pin and the contact surface of the recess. This offers significant advantages. If wear occurs on the pin due to friction or due to impacts, the pin can move deeper and deeper into the recess. In particular in combination with a pre-tensioned holder, the pin is drawn into the recess by a spring force. A particularly strong and long hold is thus also ensured when wear occurs on the pin.

In a further embodiment, the blocking device can comprise a rotatably mounted blocking disk or parts of a blocking disk, preferably on a shaft.

If the blocking device comprises a rotatably mounted blocking disk, a particularly simple construction of the blocking device is provided. In this case, the blocking disk can be formed so that it has a non-rotationally-symmetrical shape. In particular, the blocking disk can be formed in one embodiment so that it is formed reinforced in a blocking region. Therefore, on the one hand the blocking of the holding device can be improved, on the other hand, this again lengthens the service life, since in this embodiment an enhanced material strength is provided in the region of the greatest loads.

In one embodiment, a display unit having output and/or input function can be arranged in an articulated manner on the base, wherein the display unit can comprise a cover, which prevents an actuation of an actuating lever of the holding device in one position.

To prevent a misuse, an actuating lever of the holding device can be protected from the access of the driver during the operation of the motor scooter. The operation of the motor scooter can be indicated in this case by a folded-up position of the display unit. The display unit can comprise, for example, a speedometer display, and also indicate the charge state of a battery. The display unit can be a conventional display screen, for example, an LCD or OLED display screen, or also a touchscreen, for example, a capacitive or a resistive touchscreen. Thus, simple output devices are conceivable as are combined output and input devices.

In a further embodiment, the display unit can be mounted so it is rotatable on the shaft about a display axis of rotation, wherein the display unit can be operationally connected to the blocking device via the shaft for pivoting the blocking device from the first position into the second position.

It is thus possible that the blocking device is pivoted simultaneously by pivoting the display unit. The pivoting of the display unit can thus disengage the blocking of the holding device by the blocking device. In the folded-down state of the display unit, it is possible to pivot the at least one grip support. Such an embodiment results in a very simple folding-down mechanism, since the driver only has to actuate two handles in order to pivot the at least one grip support. This can be performed with one hand.

In a further embodiment, the handlebars can comprise a spring element, which can be designed for pre-tensioning the display unit in a direction toward a folded-up position.

If a spring element pre-tensions the display unit in the direction of the folded-up position, unintentional pivoting of the display unit during travel is prevented. The described embodiment thus enhances the safety of the handlebars once again.

In one embodiment, the handlebars can have a catch element, in particular spring-loaded balls, which can be designed and/or arranged to latch the display unit in the folded-up position.

Alternatively or additionally to the spring element, the display unit can be latched by a catch element in the folded-up position. More force is thus necessary to disengage the display unit from the folded-up position or it is necessary to disengage the latching in another manner.

In one embodiment, the handlebars can comprise a housing, wherein the housing can be arranged and/or designed so as to be pivotable from a folded-up position into a folded-down position, wherein the housing can block the actuating lever in the folded-up position.

If the handlebars comprise a housing, which can accommodate the display unit, for example, a further safety mechanism can thus be provided, in which the housing prevents an actuation of the actuating lever in a folded-up position.

The object is furthermore achieved by a vehicle, comprising:
handlebars as described above;
at least one drive unit;
at least one sensor unit, which is designed for detecting the position of the display unit and/or the housing and/or the blocking device;
a supply device for supplying the at least one drive unit with energy;
a control device communicatively connected to the at least one sensor unit for controlling the energy supply of the at least one drive unit by the supply device,

wherein the control device is designed for the purpose of interrupting the energy supply of the at least one drive unit if the at least one sensor unit detects that the display unit and/or the blocking device and/or the housing is/are located in the first blocking position or folded-down position, respectively.

Similar or identical advantages result with respect to the handlebars of the vehicle as were already described in conjunction with the above-described handlebars.

The display unit and/or the blocking device or the housing can be used for interrupting the energy supply of a drive unit of a vehicle. The safety is thus enhanced once again if the display unit, the blocking device, and/or the housing can be used as a type of ignition key

In one embodiment, the at least one sensor unit can be designed as an electrical switch, a distance meter, a brightness sensor, or as a mechanical switch, for example, a magnetic sensor or feeler. The at least one sensor unit can be embodied by various components. Of course, a combination of various components is also conceivable, for example, to compensate for the failure of one component.

The invention is described hereafter on the basis of exemplary embodiments, which are explained in greater detail on the basis of figures.

In the figures:

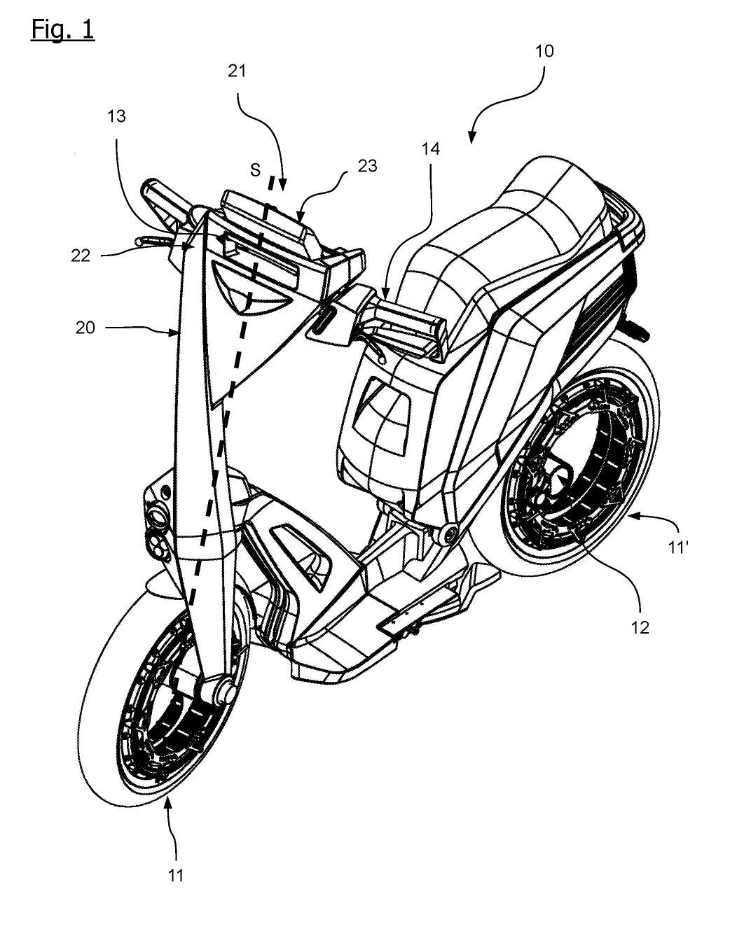

FIG. 1 shows an electrically driven and foldable motor scooter in a perspective view having handlebars;

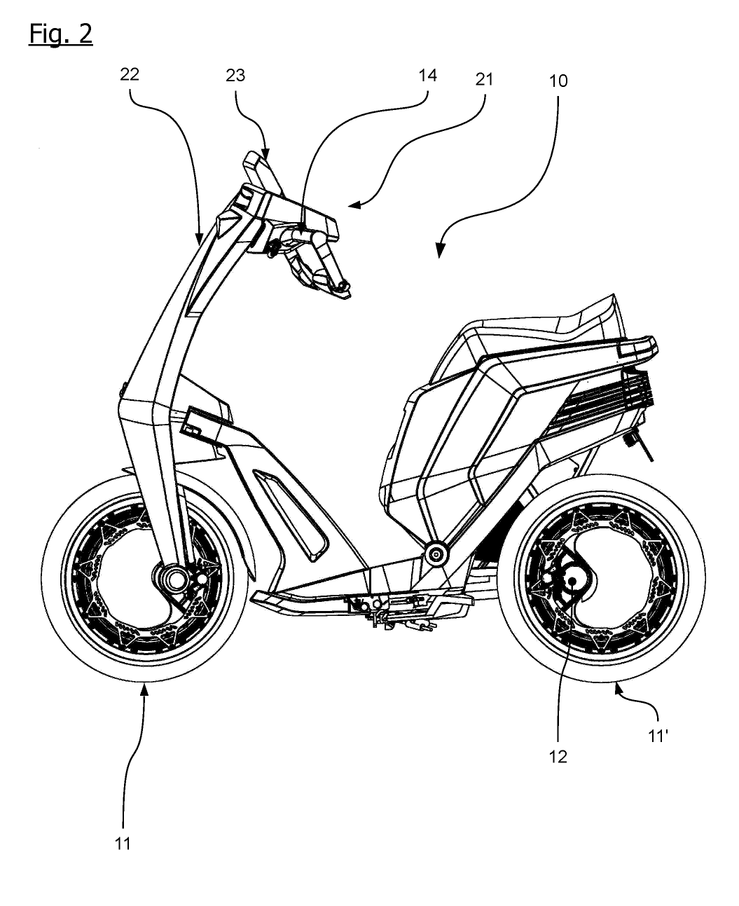

FIG. 2 shows the motor scooter from FIG. 1 in a side view;

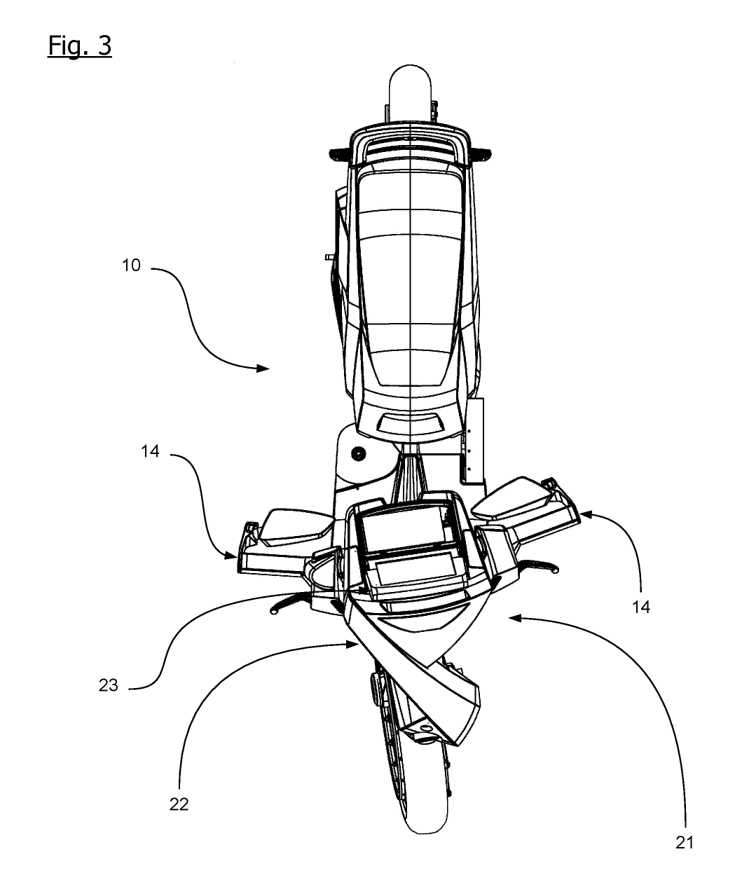

FIG. 3 shows the motor scooter from FIGS. 1 and 2 in a top view;

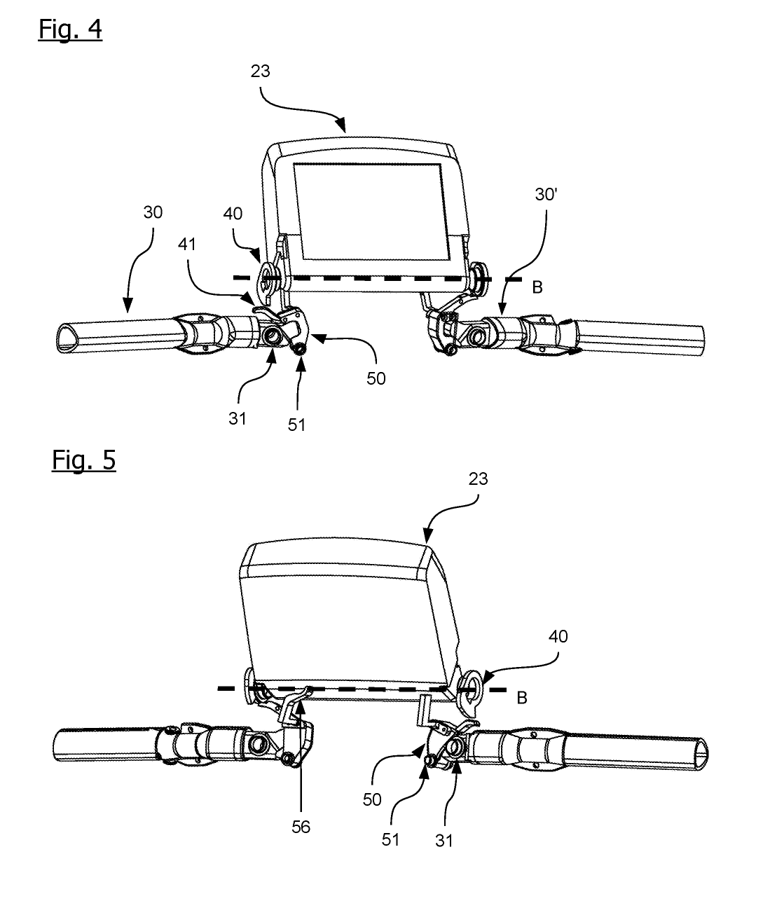

FIG. 4 shows important mechanical parts of the handlebars in a schematic rear view;

FIG. 5 shows the parts of the handlebars from FIG. 4 in a schematic front view;

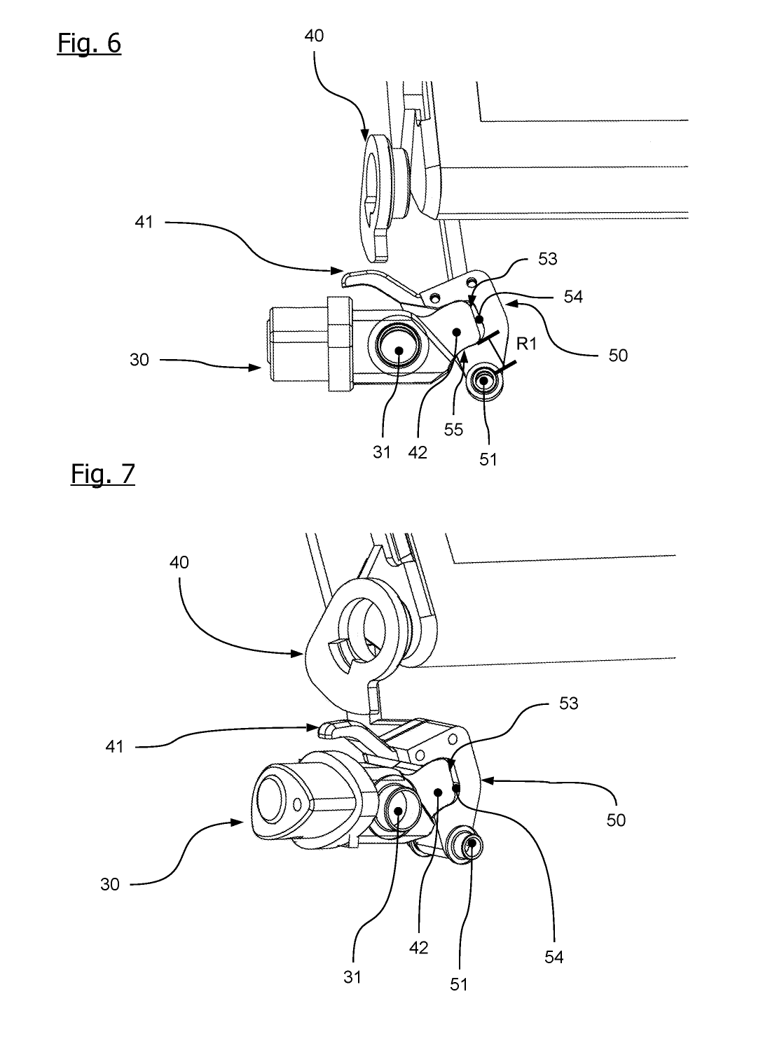

FIG. 6 shows a schematic detail view of several mechanical parts of the handlebars of FIG. 4 having a blocking device, a holding device, and a grip support (left side);

FIG. 7 shows a perspective view of the detail view from FIG. 6;

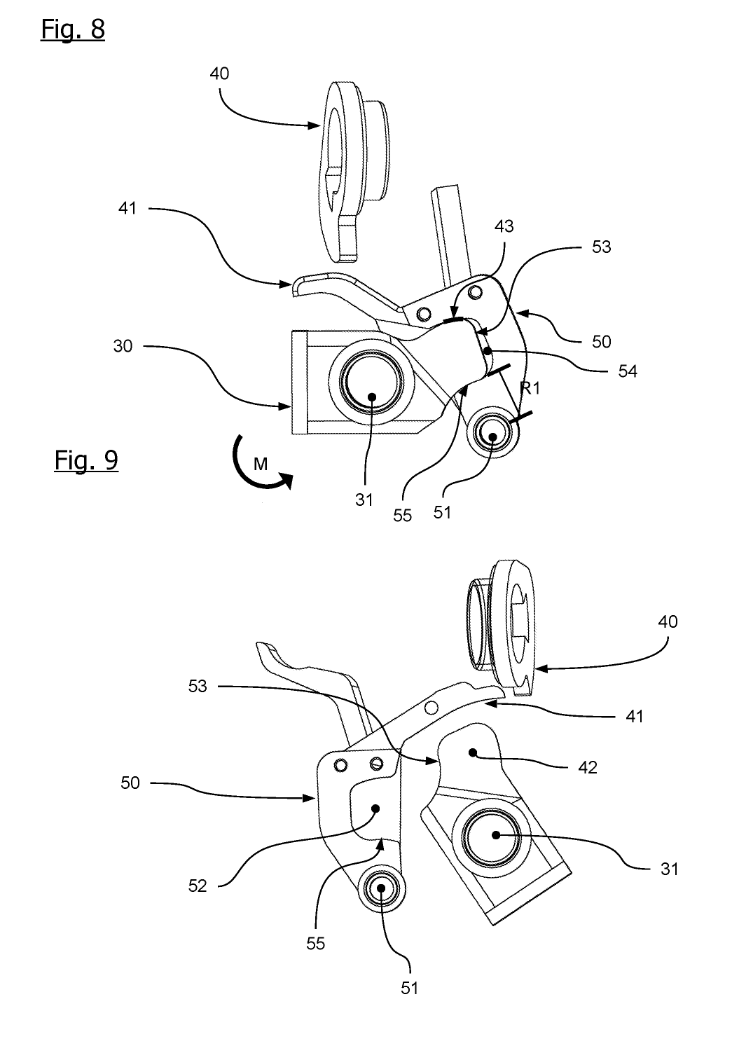

FIG. 8 shows a detail view of a blocking device, a holding device, and a grip support in a locked position;

FIG. 9 shows a detail view of the blocking device, the holding device, and the grip support in an unlocked position;

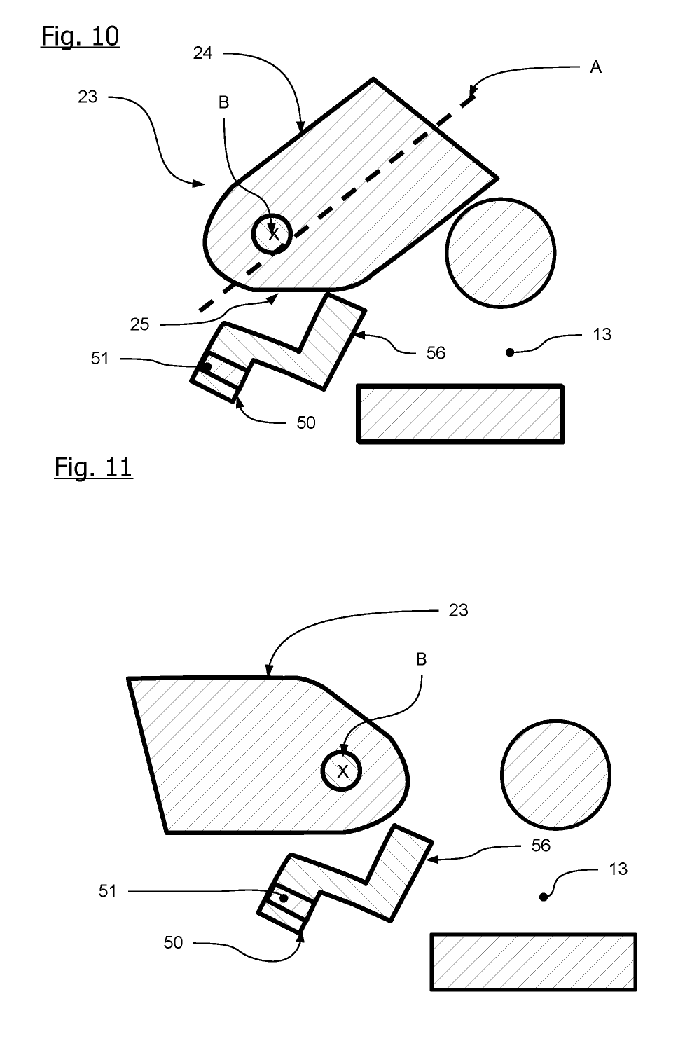

FIG. 10 shows a schematic section through a display unit having a blocking device in a blocking state;

FIG. 11 shows the section from FIG. 10 having the blocking device in an open state.

In the following description, the same reference signs are used for identical and identically acting parts.

FIGS. 1 to 3 show an electrically driven motor scooter 10 having two wheels 11, 11′ and handlebars 21 in a first exemplary embodiment. The motor scooter 10 illustrated in FIGS. 1 to 3 is a foldable motor scooter 10. The motor scooter 10 furthermore comprises a drive unit 12, which is designed as an electric motor in the first exemplary embodiment. The handlebars 21 are fixedly installed on a steering column 20, which can be pivoted about a pivot axis S, and the handlebars 21 comprise a base 22 and handles 14. The handles 14 are arranged on grip supports 30, 30′ on the base 22. The driver of the motor scooter 10 can control various functions of the motor scooter 10 via the handles 14, for example, horn, turn signals, braking, or acceleration. The grip supports 30, 30′ are each alternately articulated with the base 22. An actuating opening 13 is provided in the front region of the motor scooter 10 on the handlebars 21, into which a driver can reach and which can be used to pull the motor scooter 10 when it is collapsed.

The driver can reach an actuating lever 56 by reaching through the actuating opening 13 and disengage a locking of the handles 14 and thus collapse the handlebars 21. In this case, unlocking of the handles 14 is prevented in the folded-up state of the display unit 23 in a second exemplary embodiment. This will be explained in detail in conjunction with FIGS. 10 and 11.

FIG. 4 is a detail view of important mechanical parts of the handlebars 21 of the first exemplary embodiment, wherein paneling parts and the base 22 are not shown for the illustration of the functionality of the locking. FIG. 4 shows a display unit 23 in the folded-up position, wherein a blocking device 40 is arranged laterally on the display unit 23 in the first exemplary embodiment. The display unit 23 and the blocking device 40 are both mounted so they are rotatable on a shaft about the display axis of rotation B. The display unit 23 and the blocking device 40 can thus only be pivoted together in the first exemplary embodiment. Furthermore, FIG. 4 shows two grip supports 30, 30′, which are each arranged laterally below the display unit 23. The grip supports 30, 30′ are pivotably connected to the base 22 so they are rotatable on support joints 31. The grip supports 30, 30′ are locked by a holding device 50. The holding device 50 is pivotably connected to the base 22 via a holding joint 51. The grip supports 30, 30′ can be produced from a plurality of materials and a plurality of configurations. In the first exemplary embodiment, the grip supports 30, 30′ are formed as hollow tubes made of fiber composite material. In further exemplary embodiments, the grip supports 30, 30′ are formed, for example, as hollow aluminum or magnesium tubes. Light construction materials are preferably used, in order to reduce the weight and thus have a positive effect on the power consumption of the motor scooter 10.

FIG. 5 shows parts of the handlebars 21 of FIG. 4 in a schematic front view. In particular, FIG. 5 shows that the holding device 50 can be pivoted via actuating lever 56. In this case, the actuating lever 56 represents the element which the driver has to actuate to collapse the handlebars 21. As can be seen clearly from FIGS. 4 and 5, however, it is not possible for the driver to actuate the actuating lever 56 while the display unit 23 is located in a folded-up position. In the mentioned case, the blocking device 40 blocks blocking levers 41, which are connected to the holding device 50.

FIGS. 6 and 7 show in a detail illustration how folding up of the grip supports 30, 30′ can be prevented by the interaction of the blocking device 40, the holding device 50, and the grip supports 30, 30′. In the exemplary embodiment illustrated in FIGS. 6 and 7, the blocking device 40 is formed as a blocking disk. In the first exemplary embodiment, the blocking disk is not formed rotationally-symmetrical, but rather has a region which has a protrusion. The region of the protrusion is formed reinforced in this case, to take into consideration an elevated load on the protrusion. As can be seen from FIG. 7 in particular, the blocking disk 40 blocks a pivot of the blocking lever 41 and thus also a pivot of the holding device 50.

To ensure a secure hold of the holding device 50, it is pre-tensioned using a spring. In the first exemplary embodiment, the spring pre-tensions the holding device 50 so that the locking of the grip supports 30, 30′ is ensured, i.e., in the direction of the locking position of the holding device 50. In this case, the spring is arranged on the holding device 50 in a region between holding joint 51 and support joint 31 and on the base 22 in a region between holding joint 51 and support joint 31. The spring has the result that when the grip supports 30, 30′ are folded up, they snap into the holding device 50.

The interaction of the blocking device 40 with the holding device 50 furthermore has the result that unintentional folding down of the grip supports 30, 30′ is not possible. Furthermore, because the display unit 23 is operationally connected to the blocking device 40, it is ensured that folding down of the grip supports 30, 30′ is not possible in a folded-up position of the display unit 23. It is therefore not possible for a driver to fold down the grip supports 30, 30′ during the operation of the motor scooter 10.

FIGS. 8 and 9 show the blocking device 40, the holding device 50, and the grip supports 30, 30′ in a locked position and a folded-down position.

In the exemplary embodiment shown in FIG. 8, the grip support 30, 30′ is designed so that on its end toward the holding device 50, a pin 42 engages in a recess 52 of the holding device 50. The exemplary embodiment shown offers advantages in particular with respect to wear of the materials, as explained in detail hereafter.

The recess 52 of the holding device 50 is designed so that a contact surface 55 at least partially follows along a circle having a radius R1 around a holding joint 51. The pin 42 of the grip support 30, 30′ is formed substantially complementary to the recess 52. The pin 42 therefore bears uniformly and over a large area with its delimitation surface 53 on the contact surface 55 in the locked position.

The recess 52 is furthermore formed substantially tapering, wherein the degree of the taper decreases in the rear region of the recess 52. In the illustrated exemplary embodiment, the pin 42 is also formed tapered, but the degree of the taper is less than that of the recess 52. As shown in FIG. 8, a cavity 54 thus results between pin 42 and the holding device 50 in the locked state. The pin 42 is clamped at its upper and lower delimitation surfaces 53 by the holder 50 and has no play.

During the use of the handlebars 21 by a driver, an increased load occurs in a wear region 43 on the pin 42 and the holding device 50 as a result of an induced torque M. After long use, increased wear can occur in particular in the wear region 43 and the grip support 30, 30′ could be seated loosely after wear. Because the holding device 50 is pre-tensioned by a spring element, however, the pin 42 is drawn deeper into the recess 52, wherein the cavity 54 becomes smaller. An optimum seat of the grip support 30, 30′ is therefore also ensured during a continuous load, during which wear occurs. Because a cavity 54 is provided between holding device 50 and the pin 42, the service life of the handlebars 21 is thus extended. Furthermore, handlebars which are not seated solidly represent a significant safety risk.

Furthermore, FIG. 8 shows that the pin 42 is formed extending away from the longitudinal axis of the grip support 30, 30′ at an acute angle. The holding device 50 not only engages laterally in the pin 42, but rather slightly from above. Under load of the grip support 30, 30′, the pin 42 thus presses into the recess 52 such that the pin 42 is pressed into the recess 52.

FIG. 9 shows the blocking device 40 in a nonblocking position. In the illustrated position, the actuating lever 56 of the holding device 50 can be actuated, and the holding device 50 can be pivoted from a locked into an unlocked position. The grip support 30, 30′ can subsequently be folded down.

FIGS. 10 and 11 show a further advantage of the described handlebars 21. FIG. 10 is a schematic sectional view of the handlebars 21 through the display unit 23, wherein the display unit 23 and the holding device 50 are shown. FIG. 10 shows the display unit 23 in a folded-up position. In the illustrated folded-up position of the display unit 23, the display unit 23 blocks the actuating lever 56 of the holding device 50. The driver of the motor scooter 10 therefore cannot pivot the holding device 50.

FIG. 11 shows the display unit 23 in a folded-down position. As is clear from FIG. 11, the actuating lever 56 can now be actuated through the actuating opening 13 and the holding device 50 can be pivoted via the holding joint 51.

In the illustrated exemplary embodiment, a blocking surface 25 is formed substantially flat and is arranged below a display axis of rotation B in the folded-up position. The display axis of rotation B of the display unit 23 is offset toward a front side 24 of the display unit 23 from a center axis A of the display unit 23 in the illustrated exemplary embodiment, wherein the center axis A extends from an upper to a lower end of the display unit 23. Furthermore, the actuating lever 56 of the holding device 50 is arranged such that the blocking surface 25 of the display unit 23 prevents pivoting of the holding device 50 in the folded-up position of the display unit 23.

In one exemplary embodiment, the energy supply of the drive unit 12 can also be interrupted by folding closed the display unit 23. In this case, the folding closed of the display unit 23 results in the actuation of a switch, which is arranged between display unit 23 and the operating panel located underneath. The switch transmits a signal upon actuation to a control device, which interrupts the current flow from a battery to the drive unit 12 as a reaction thereto.

It is to be noted at this point that all above-described parts are claimed as essential to the invention considered alone and in any combination, in particular the details illustrated in the drawings. Modifications thereof are routine for a person skilled in the art.

### LIST OF REFERENCE SIGNS

10 motor scooter
11, 11′ wheels
12 drive unit/electric motor
13 actuating opening
14 handle
20 steering column
21 handlebars
22 base
23 display unit
24 front side
25 blocking surface
30, 30′ grip support
31 support joint
40 blocking device
41 blocking lever
42 pin
43 wear region
50 holding device
51 holding joint
52 recess
53 delimitation surface
54 cavity
55 contact surface
56 actuating lever
S pivot axis
A center axis
B display axis of rotation
R1 first radius

1. Handlebars having a base for use in a vehicle, comprising:
at least one grip support, which is arranged in an articulated manner on the base and is pivotable from a first support position into a second support position;
a holding device, which is arranged and/or designed such that the holding device is pivotable in an articulated manner from a first holding position into a second holding position, wherein the holding device locks the grip support with the base in the first holding position;
a blocking device, which is arranged in an articulated manner on the base and is pivotable from a first blocking position into a second blocking position, wherein the blocking device is arranged and/or designed such that the blocking device blocks the holding device in the first blocking position.

2. The handlebars according to claim 1,
characterized in that
the at least one grip support is held at least partially in a formfitting and/or friction-locked manner in the holding device in the first holding position.

3. The handlebars according to claim 1,
characterized in that
the holding device is mounted via a holding joint so it is rotatable on the base about a holding device axis of rotation.

4. The handlebars according to claim 1,
characterized in that
the holding device is pre-tensioned via a spring element in the first holding position.

5. The handlebars according to claim 4,
characterized in that
a recess of the holding device is formed corresponding with a pin of the at least one support; and/or
the pin and the recess are arranged and/or designed such that the pin engages in the recess for locking in the first holding position.

6. The handlebars according to claim 5,
characterized in that
at least one contact surface of the recess is formed at least partially following a first radius around the holding device axis of rotation; and/or
at least one delimitation surface of the pin is formed at least partially following a second radius around the holding device axis of rotation in the first support position, and/or
the recess and the pin are arranged and/or designed substantially complementary and the recess is formed in a tapering shape in a direction substantially transverse to the holding device axis of rotation.

7. The handlebars according to claim 1,
characterized in that
the blocking device comprises a rotatably mounted blocking disk or parts of a blocking disk.

8. The handlebars according to claim 1,
characterized in that
a display unit having output and/or input function is arranged in an articulated manner on the base, wherein the display unit comprises a cover, which prevents an actuation of an actuating lever of the holding device in one position.

9. The handlebars according to claim 1,
characterized in that
one/the display unit is mounted so it is rotatable on a shaft about a display axis of rotation, wherein the display unit is operationally connected to the blocking device via the shaft for pivoting the blocking device from the first blocking position into the second blocking position.

10. The handlebars according to claim 8,
characterized in that
the handlebars comprise a spring element designed to pre-tension the display unit in a direction toward a folded-up position; and/or
the handlebars have a catch element, in particular spring-loaded balls, designed and/or arranged to latch the display unit in the folded-up position.

11. The handlebars according to claim 8,
characterized in that
the handlebars comprise a housing, wherein the housing is arranged and/or designed such as to be pivotable from a folded-up position into a folded-down position, wherein the housing blocks one/the actuating lever in the folded-up position.

12. A vehicle, comprising:
handlebars including;
at least one grip support, which is arranged in an articulated manner on a base and is pivotable from a first support position into a second support position;
a holding device, which is arranged and/or designed such that the holding device is pivotable in an articulated manner from a first holding position into a second holding position, wherein the holding device locks the grip support with the base in the first holding position; and
a blocking device, which is arranged in an articulated manner on the base and is pivotable from a first blocking position into a second blocking position, wherein the blocking device is arranged and/or designed such that the blocking device blocks the holding device in the first blocking position;
at least one drive unit;
at least one sensor unit, which is designed to detect the position of the display unit and/or of the housing and/or of the blocking device;
a supply device for supplying the at least one drive unit with energy;
a control device communicatively connected to the at least one sensor unit for controlling the energy supply of the at least one drive unit by the supply device, wherein
the control device is designed to interrupt the energy supply of the at least one drive unit if the at least one sensor unit detects that the display unit and/or the blocking device and/or the housing is/are located in the first blocking position respectively folded-down position.

13. The vehicle according to claim 12,
characterized in that
the at least one sensor unit is designed as
an electric switch,
a distance meter,
a brightness sensor, or as
a mechanical switch, in particular as a magnetic sensor.
